(19) United States
(12) Patent Application Publication
(10) Pub. No.: US 2006/0036558 A1
(43) Pub. Date: Feb. 16, 2006

(54) Universal serial bus scale

(76) Inventor: David Kent Mathews, Forth Worth, TX (US)

Correspondence Address: HOWISON & ARNOTT, L.L.P, P.O. BOX 741715, DALLAS, TX, 75374-1715, US

(21) Appl. No.: 10/917,014

(22) Filed: Aug. 12, 2004

(51) Int. Cl. G01G 19/413

(52) U.S. Cl. 705/414; 705/407

(57) ABSTRACT

A system and method for providing weight data from a computer to a website is disclosed. The system includes a weight scale connected to the computer via a universal serial bus connection. Computer readable storage media contains machine readable code for configuring a processor in the computer to send the weight data to the web site responsive to receipt of the weight data at the computer from the universal serial bus scale.

### TECHNICAL FIELD OF THE INVENTION

The present invention relates to a universal serial bus scale, and more particularly, to a universal serial bus scale that may place a measured weight into a field of a Web page accessed via the Internet.

### BACKGROUND OF THE INVENTION

Universal serial bus devices enable a user to easily connect a peripheral device such as a printer, scanner, etc. to their personal computer with a minimum of effort. In most cases, the universal serial bus device can be plugged into the personal computer and automatically configure itself to enable almost instantaneous use of the device.

The use of electronic postage and the necessity of determining shipping weights for shipping items via the U.S. mail or shipping services such as UPS, DHL or FedEx, in home offices and other locations has been increasing. A scale may be used for determining the weight of an item to be mailed or shipped. A computer may be used for storing, processing and running software which is designed to apply to specific tariff or shipping rate billing data in response to a weight input from the scale. However, all of these computations are performed locally on the computer. There also exist Web sites able to perform shipping cost calculations. However, a user is required to manually enter a weight to receive cost estimates from the Web site. This requires a user to make guesses as to a weight of an item and runs the risk of incorrect data entry if the weight entered is incorrect.

The ability to more quickly and efficiently enter weight information into a shipping Web site would provide users with a method of quickly and accurately determining shipping cost. Thus, there is a need for a scale device capable of quickly and accurately entering weight information into a remote Web site.

### SUMMARY OF THE INVENTION

The present invention disclosed and claimed herein, in one aspect thereof, comprises a system and method for providing weight data from a computer to a website. The system includes a weight scale connected to the computer via a universal serial bus connection. Computer readable storage media contains machine readable code for configuring a processor in the computer to send the weight data to the web site responsive to receipt of the weight data at the computer from the universal serial bus scale.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates the operating environment of the system;

FIG. 2 is an illustration of a USB scale;

FIG. 3 is a functional block diagram illustrating the interconnection between a USB scale, personal computer and the Internet;

FIG. 4 illustrates a display on a graphical user interface associated with the USB scale of the present disclosure;

FIG. 5 illustrates a drop down menu of autolaunch sites for the USB scale of the present disclosure;

FIG. 6 is a diagram illustrating the flow between various operations of the software associated with the USB scale during setup;

FIG. 7 is an illustration of the overall process flow of the software associated with the USB scale;

FIG. 8a is an illustration of a push operation;

FIG. 8b is an illustration of a pull operation;

FIG. 9 is a block diagram illustrating an interconnection between a host device and a peripheral device interconnected via a USB connection;

FIG. 10a is a diagram of operation of the USB protocol between a host and USB devices;

FIG. 10b is a diagram of a control transfer;

FIG. 10c is a block diagram illustrating a manner in which a newly connected device is detected by a host controller via a USB connection;

FIG. 11 is a functional block diagram of the USB scale of the present disclosure;

FIG. 12 is a flow diagram illustrating a push operation to enter weight data using the USB scale of the present disclosure;

FIG. 13 is a flow diagram illustrating a pull operation to enter weight data using the USB scale of the present disclosure; and

FIG. 14 is a functional block diagram of an alternative embodiment of the USB scale.

### DETAILED DESCRIPTION OF THE INVENTION

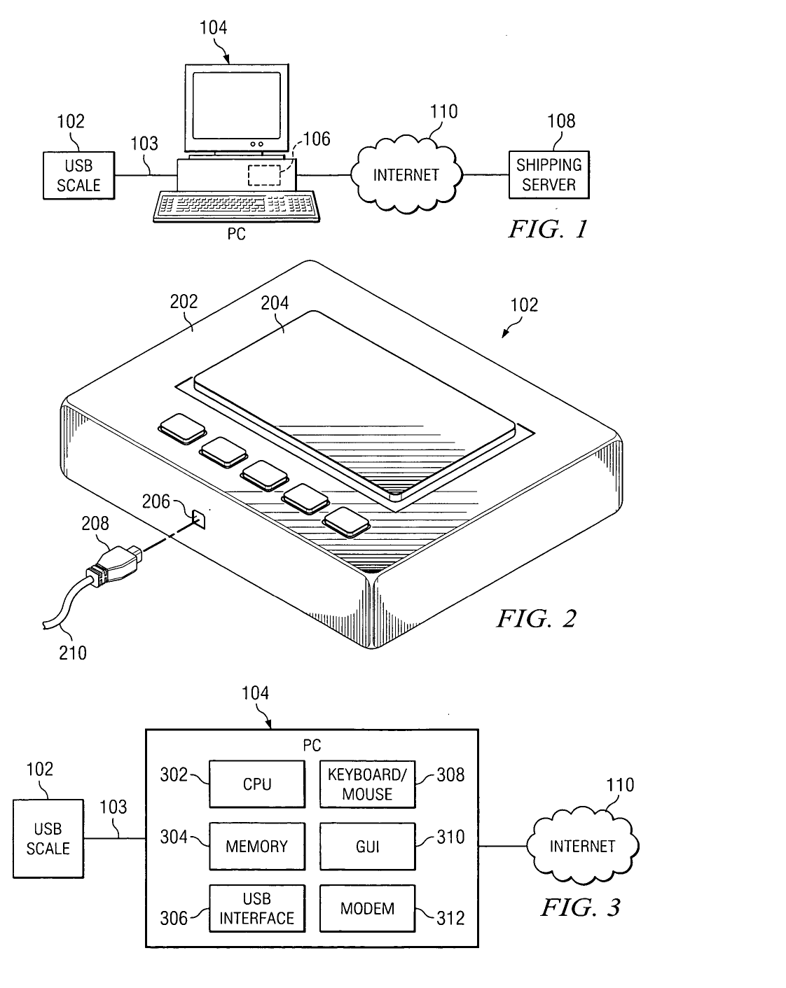

Referring now to the drawings, and more particularly to FIG. 1, there is illustrated a USB scale 102 connected in the operating environment of the present disclosure. The USB scale 102 interconnects with a PC 104 via a universal serial bus connection 103. The USB connection 103 consists of a USB cable including two pairs of twisted wires. One pair of wires carries power from a host computer to the USB scale 102. In the other pair, each wire carries signals in the form of voltage pulses, with a protocol such that the relativity of the pulses between the wires not only provides packets of data but indicates one of two available transmission speeds and zero signals that may signify end of packet or disconnect. The PC 104 governs the sending and receiving of the USB signals between the PC 104 and USB scale 102. The cable passes data both ways, with the USB transceiver selectively coordinating the traffic so that the signals are sent only one way at a time. The USB specification also limits cable lengths for reasons that include specifications on voltage, current, impedance limitations, signal/noise limitations and cable propagation.

Stored on the PC 104 is USB scale software 106 for enabling weight data generated by the universal serial bus scale 102 to be automatically provided to a weight field of a Web site on a shipping server 108 over the Internet 110 and to, in general, provide the necessary set of instructions for allowing the USB scale 102 to interface with the PC 104 and server 108. Thus, by placing an item to be weighed upon the universal serial bus scale 102, this weight data can be recognized by the software 106 within the PC 104, and the software 106 will actuate a connection with a shipping server 108 over the Internet 110 to populate a weight field within a Web page stored upon the shipping server 108, i.e., it will “push” the weight information to the server 108. The Web server 108 may be associated with any number of postage or shipping Web sites including, but not limited to the U.S. Postal Service, UPS, DHL, Federal Express, eBay, Stamps.com, and any number of other shipping entities that require the input of weight information from an accessing user. The PC 104 may consist of any computing device having universal serial bus capabilities such as a laptop computer, desktop computer, cellular telephone, personal data assistant or any other type of electronic device providing the functionalities described herein.

Referring now to FIG. 2 there is illustrated a view of the universal serial bus scale 102 of the present disclosure. The universal serial bus scale 102 includes a housing 202 containing all of the mechanisms and hardware necessary for providing weight measurements of a package or item placed upon the universal serial bus scale 102. A weight pad 204 is located on top of the housing 202 and is of a size to enable the placement of an item that is to have its weight determined placed thereon. The size of the housing 202 and the weight pad 204 will be dependent upon the weight ranges desired to be measured by the USB scale 102. For smaller items such as letters and small packages, the housing 202 and weight pad 204 could comprise approximately the size of 6 inches by 6 inches. For larger and heavier packages, the housing 202 and weight pad 204 would be required to be much larger in order to accommodate the size and weight associated with such larger packages. The scale has 1 oz. “sensitivity” but does not autolaunch to a site until at least 5 oz. of weight is registered on the scale. This will prevent the scale from “misfiring” if you drop a book on your desk and cause the scale's weight pad to strain the load cell. The weight on the scale will be shown for under 5 oz. when the display is active. The housing 202 also includes a USB port 206 for receiving a USB connector 208 connected to a USB cable 210. The USB connector 208 is configured to connect to the USB port 206 of the USB scale 102 and provide bi-directional communications over the universal serial bus cable 210 interconnecting the USB scale 102 to an associated PC 104, and also supply power to the USB scale 102.

Referring now also to FIG. 3, there is more fully illustrated the PC 104 interconnected to the USB scale 102 via the USB cable 103 and to the Internet 110. The PC 104 includes a number of standard components associated with most PC devices including a central processing unit 302 for performing all processing functionalities of the USB scale software 106. The CPU 302 is used for processing functionalities of the personal computer 104. With respect to the present disclosure, the CPU 302 is operable for receiving weight data from the USB scale 102 and forwarding the weight data to a shipping server via the Internet 110. The CPU 302 is under the control of the USB scale software 106 which is stored within a memory 304 of the personal computer 104. The software 106 will be stored within the memory 304 during an installation process and controls all operations of the CPU 302 with respect to the USB scale 102. These operations would include receiving and recognizing weight data from the USB scale 102 and automatically accessing a shipping server 108 connected to the Internet 110 using a browser interface of the personal computer 104 responsive to the receipt of weight data from the USB scale 102. The web site comprises the predetermined Web site autolaunch information provided by a user during the installation process. The Web site autolaunch information is the Web site location which is automatically accessed by the USB scale software 106 responsive to an item being weighed on the USB scale 102.

A universal serial bus interface 306 provides for an interconnection between the USB cable 103 and the PC 104. The universal serial bus interface 306 operates according to the USB 1.0 protocol and will be discussed more fully herein below and is hereby incorporated by reference. Alternatively, the USB 2.0 or additional protocols might be used. A keyboard/mouse 308 provides a user interface with the personal computer 104 and enables a user to set up the universal serial bus scale software 106 in a desired manner. Through the keyboard/mouse 308, a user may install the USB scale software 106 and select an autolaunch Web site that is accessed in response to the receipt of weight data from the USB scale 102. Used in connection with the keyboard/mouse 308 is a graphical user interface 310 providing the user with a visual interface to the USB software 106. The graphical user interface 310 in connection with the keyboard/mouse 308 provides the user with an easy method for configuring the universal serial bus scale software 106 in a desired manner and accessing the functionalities thereof.

A modem 312 provides a connection between the PC 104 and the Internet 110. The modem 312 may be ofany number oftypes including a modem enabling a dial-up connection, a DSL connection, a cable connection, a satellite connection or any other type of modem connection that may be provided between a computing device 104 and the Internet 110, and the modem 312 could represent a Network Interface Card (NIC) for interfacing to an Ethernet network mesh.

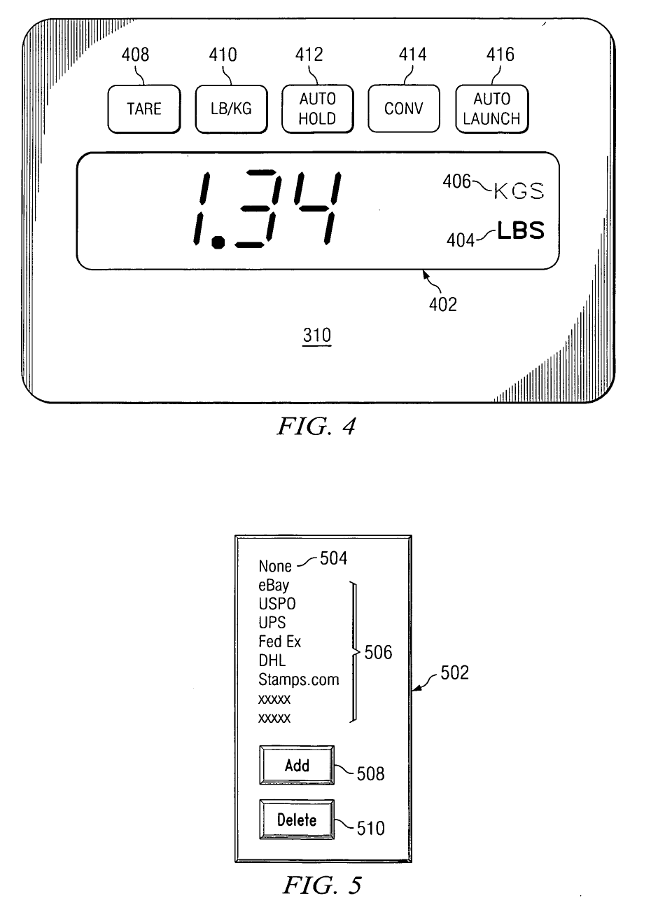

Referring now to FIG. 4, there is provided an example of a graphical user interface 310 provided when weight data is being provided from the USB scale 102 to the PC 104. The graphical user interface 310 comprises a screen or window provided on a monitor of a user's personal computer 104. A first portion of the graphical user interface 310 is the weight window 402. The weight window 402 provides a visual display of the weight of the item being weighed upon the weight pad 204 of the universal serial bus scale 102. The weight window 402 provides a numeric indication in an LED-type display of the weight of the item on the weight pad 204. In the illustration of FIG. 4, a weight of 1.34 pounds is illustrated with the units of weight being indicated by a pounds indicator 404 in the bottom right-hand corner of the weight window 402. A second kilograms indicator 406 shown in phantom in the upper right-hand corner of the weight window 402 may also be displayed if a selection is made by the user to display the weight in kilograms rather than pounds.

The graphical user interface 310 additionally includes a number of activation buttons which may be selected by a user using a mouse in a point and click fashion which is well known in the art. The buttons on the graphical user interface 310 include a tare button 408, a pounds/kilogram button 410, an autohold button 412, a conversion button 414 and an autolaunch button 416. The tare button 408 is used to zero out the USB scale 102. The tare button 408 may be actuated by a user when no item is resting upon the weight pad 204 in order to insure that the USB scale 102 is registering a zero weight when nothing is on the scale. Additionally, if the item to be shipped was required to be placed within some type of container in order to be accurately weighed, the container may first be placed upon the weight pad 204, and the tare button 408 actuated in order to zero out the USB scale 102 with respect to the container. The item to be weighed may then be placed inside the container such that an accurate measurement of its weight may be obtained.

The pound/kilogram button 410 is used for selecting between measurement of the weight of an item on the USB scale in either pounds or kilograms. In response to activation of the pound/kilogram button 410 the weight in the weight window 402 will be displayed either with an associated pounds indicator 404 or kilograms indicator 406 depending on which of the weight measurement units have been selected. The autohold button 412 is used to hold a weight value in the USB scale 102 even after the item has been removed from the USB scale 102. Thus, an item may be placed on the scale and removed, and the weight value would be preserved if the autohold button 412 were pressed while the item was on the scale. The conversion button 414 converts an already measured weight reading into a different measurement unit. Thus, pounds can be converted to kilograms and vice versa. The autolaunch button 416 causes the software to look for weight on the USB scale 102 and launch a predetermined Web site automatically. The autolaunch button 416 may also in other embodiments enable the selection or designation of a Web site to which the USB scale software 106 will automatically provide weight data responsive to placement of an item upon the weight pad of the USB scale 102. By selecting the autolaunch button 416, a drop down menu will be displayed containing information as illustrated in FIG. 5.

It should be understood that the drop down menu illustrated in FIG. 5 provides merely one example of a drop down menu which may be used with the autolaunch functionality of the present disclosure. Numerous other configurations are possible. The drop down menu 502, initiated by activation of the autolaunch button 416, provides a first option 504 in which no autolaunch site is selected for activation upon receipt of weight data by the universal serial bus software 106. This option may be utilized if it is only desired for the USB scale to obtain weight data locally by the user without transmitting it to a shipping or postage Web site. A number of pre-established Web site options 506 are also provided enabling a user to select one of the Web sites to which the USB scale software 106 may automatically launch. Examples of these Web sites include the commercial Web sites associated with eBay, United States Post Office, UPS, Federal Express, DHL, Stamps.com, and any other number of Web sites that may have commercial shipping or postage services associated therewith. After selection of one of these Web sites, the USB scale software 106 will automatically open the selected Web site in response to receipt of weight data from the USB scale 102 using a browser of the PC 104. Additionally, an add selection option 508 may be provided within the drop down menu 502 to enable a user to add a Web site to which the USB scale software may automatically gain access responsive to the receipt of weight data. The Web site would be added by going to the appropriate page and clicking on the add button when a Web browser is presently accessing a page that is to be added in much the same way that additional Web sites may be added to a Favorites folder of a Web browser. Additionally, a delete selection option 510 is provided to enable a user to delete Web sites from the active list 506 that are either no longer used by the user.

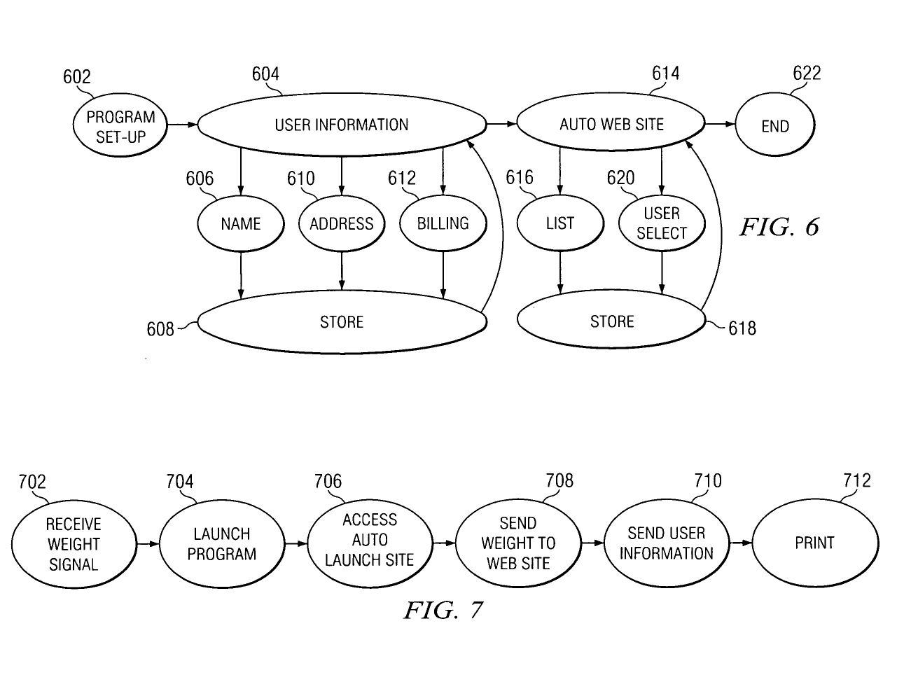

Referring now to FIG. 6, there is illustrated the program flow for setting up the USB scale software 106 once it has been loaded into a PC 104 connected to the USB scale 102. The program setup is initiated at 602 by a user launching the software installation associated with the USB scale if the software has not been previously set up. The first step involves the provision of user information at 604 such that shipping label and billing label information may be easily provided to a Web site when this information is required. Once the user information process 604 is entered, the USB scale software 106 will ask for a user name at 606. Once the user name information has been entered at 606, this information is stored at 608. The process returns to the main user information process 604 and requests at 610 address information from the user entered in step 606. Once the address information is received at 610, this information is stored at 608 and control passes back to the user information process 604. Finally, billing information 612 is requested of the user. Billing information may include credit card information, bank draft information, Pay Pal account or any other information required to pay for postage/shipping of packages which may be weighed upon the USB scale 102. Once the billing information has been entered at step 612, it is stored at process 608 and control passes back to the user information process 604. Once all of the user information is provided at process 604, control will pass to the autolaunch Web site process 614. The autolaunch Web site process 614 may be executed in one of two manners. In the list process 616, the autolaunch Web site is selected from a list of Web sites provided within the software package 106. This list of autolaunch sites may include a similar list as described with respect to FIG. 5. Once a provided autolaunch list member is selected, this information is stored at process 618 and control passes back to process 614. Alternatively, process 620 allows the user to enter and select an autolaunch Web site that has not been provided in a pre-determined list within the software package 104. Once the user enters the name and appropriate Web site information for this user selected auto Web site at process 620, the information is stored at process 618 and control passes back to process 614. Once the autolaunch Web site information has been established at process 614, the process will end at 622.

Referring now to FIG. 7, there is illustrated the process flow for the USB scale 102 and associated software 106 stored upon a PC 104 when a item to be shipped or mailed is placed upon the USB scale 102. The USB scale software 106 is initially off but is actuated upon receipt of a weight signal at 702. Upon receipt of the weight signal at 702, the USB scale program 106 is launched at step 704. After launch of the USB scale program 106, the program determines at step 706 the autolaunch Web site which has been established by the user, and accesses the autolaunch Web site using a Web browser associated with the PC 104. Once the appropriate autolaunch site has been accessed, the USB scale software 106 will send weight data to the Web site to be populated in appropriate forms on the Web site requiring weight information. The process of sending the weight information to the autolaunch Web site may be carried out either as a push function or a pull function as will be more fully described herein below. Once the appropriate weight information has been entered into the weight fields of the Web site, additional user information may be provided at 710 to other fields of the Web site as necessary. This information may include user name, user shipping address and user billing information such as a credit card, Pay Pal account or bank account number. Once the user information has been provided at step 710, the appropriate postage or billing labels may be printed by a user at 712 as appropriate.

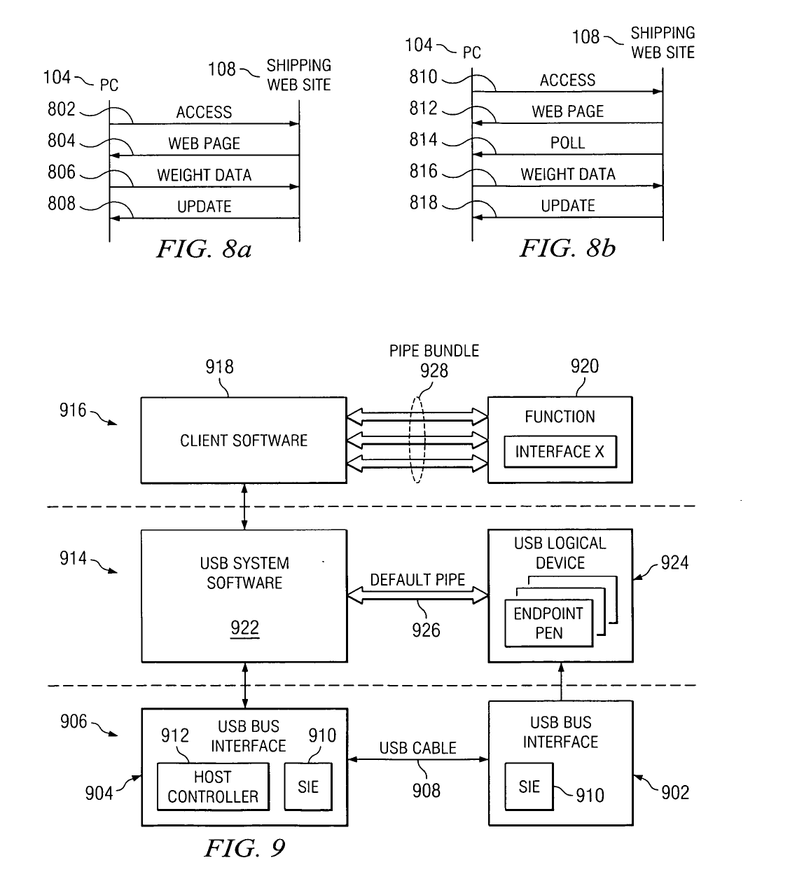

As described above, the transmission of the weight data from the USB scale software 106 to a weight field of a Web site, may consist of either a push operation or a pull operation from the perspective of the client PC. A push operation in client server applications is a method of sending data from a server at a remote location to a client without the client requesting it. A pull operation involves a request for data from another program or computer. The Internet is based upon pull technology wherein a page is not delivered to a browser until it is requested. As described herein above, there are times when a user of the PC 104 may wish to push data to a particular Web page on a shipping server 108 in order to provide shipping information. (This is referred to as a “client push”). FIG. 8A illustrates a push operation between the PC 104 and a shipping Web server 108. The PC 104 initiates an access 802 between the PC 104 and the shipping Web site 108 using, for example, a browser associated with the PC 104 to enable connection there between. In response to the access 802 of the shipping Web server 108 by the PC 104, the server 108 transmits the Web page 804 back to the PC 104. The PC 104 under control of the USB scale software 106, without any request on the part of the shipping Web server 108, pushes the weight data 806 received from the USB scale 102 from the PC 104 to the shipping Web server 108. The shipping Web server 108 provides an update 808 back to the PC 104 to reflect the weight data provided to the shipping Web server 108. As can be seen, in the above described client push operation, no request for the weight data is made from the shipping Web site 108 to the PC 104. The PC 104 merely pushes the weight data 806 to the shipping Web site 108 once they are connected.

Alternatively, a pull technology may be used to transmit the weight information from the USB software 106 to the shipping server 108. FIG. 8B illustrates a pull operation between a PC 104 and the shipping Web server 108. The PC 104 initially transmits an access 810 to the shipping Web site using a browser within the PC 104. In response to the access 810, the shipping Web server 108 sends a Web page 812 back to the PC 104. Once the connection between the PC 104 and shipping Web server 108 is established, the shipping Web server 108 will poll the HID (Human Interface Device) drivers of the PC 104 using Active X, Java script or similar type clients to obtain the necessary weight data. (This is referred to as a “server pull”). In response to the server pull 814, the PC 104 transmits the weight data 816 back to the shipping Web server 108. The shipping Web server 108 provides an update 818 back to the PC 104 indicating the new Web page in response to the provided weight data 816. Note that the client PC 104 undergoes the server pull operation when the server 108 has been accessed by the client PC 104. For example, if the main address of the Web server 108 is accessed by the PC 104 through transmission of a TC/IP request packet transmitted thereto, the Web server 108 may first pull the PC 104 through transmission of HTML commands thereto and retrieve information regarding whether weight data is available. Thereafter, the web page could be returned with the weight field already populated.

Referring now to FIG. 9, there is illustrated the communication layers that exist between the USB host 904 and a connected USB device 902. The physical layer 906 comprises the physical interface to the USB cable 908. The physical layer 906 consists of the USB cable 908 and its main responsibility is to transmit and receive ones and zeros between the USB host 904 and the USB device 902. The USB cable 908 interconnecting the USB host 904 and the USB device 902 is a four wire cable. Signaling on the USB cable 908 is done by signaling over two of the wires referred to as the differential pair. A D+ wire and a D− wire comprise the differential pair. If a zero is to be transmitted over the USB cable 908, the D+ wire is maintained low and the D− wire is maintained high. If a logical one is to be transmitted over the USB cable, the D+ wire is held high and the D− wire is held low. The other two wires of the USB cable 908 comprise the V+ line (+5 volts) and the ground line (−5 volts) and deliver power to a connected USB device 902. Bits are transmitted over the D+ wire and D− wire such that the least significant bits are transmitted first.

Data encoding and decoding is done using NRZI coding. In NRZI coding if it is desired to transmit a logical one, the leveling of the signaling is not changed. Thus, if the differential pair are representing logic “1,” the differential pair will remain at this level for the next clock cycle. If a logic “0” is to be transmitted, the value of the differential pair is flipped. Thus, there will be a toggle in the level such that if the current value represented is differential “1,” the next value will be “0.” By using the NRZI method of data encoding, transmission of a string of ones will cause a continuous mode of transmission wherein the transmission line remains static with no changes during that period. In order to prevent this continuous state, bit stuffing is performed during the NRZI encoding. Bit stuffing is accomplished by inserting a zero after six successive ones. The decoder recognizes the zero as part of the bit stuffing and ignores it.

The serial interface engine (SIE) 910 is part of both the USB host physical layer and the physical layer of the USB device 902. Data is transmitted on the USB bus 908 as a serial bit stream. The SIE 901 is responsible for the serialization and deserialization (converting the data stream to a parallel stream) of the USB transmissions. The incoming data stream is NRZI and bit stuff decoded. The outgoing traffic is NRZI and bit stuff encoded. The SIE 910 is responsible for these operations of decoding and encoding. The SIE 910 is also responsible for generating CRC for the outgoing data and verifying CRC for the incoming data. The SIE 910 also detects the packet I.Ds (PIDs) as well as the SOP, EOP, reset and resume signaling on the USB bus 908.

The USB host 904 initiates all transactions in the USB system, controls the media access within the USB system and is the main engine for the protocol flow. The USB host controller 912 insures that data transmitted over the USB cable 908 is correct and within the required specifications. The host controller 912 serves both the USB and the USB host 904 and has the same functionality in every USB system. The host controller 912 is responsible for frame generation within the USB system. The host controller 912 handles requests for data to and from the USB host 904 and handles the USB protocol level interface. The USB host controller 912 is also responsible for error handling such as time out errors, CRC errors and unexpected data payloads. Finally, the host controller 912 is able to enter the USB system into a suspend state and detect a remote wake-up signal on the USB bus.

The protocol engine layer 914 is responsible for the translating of data between the application layer 916 (client software 918 on the USB host 904 and functions 920 within the USB device 902) and the USB transaction protocol. The protocol engine layer 914 wraps and unwraps data according to the protocol The protocol engine layer 914 is referred to in the USB host 904 as the USB system software 922. Within the USB device 902 the protocol engine layer is called the USB logical layer 924. The USB system software 922 is composed of the host software and a host controller driver (HCD) and a USB driver (USBD). The HCD is an interface to the host controller 912. The HCD makes it transparent for the host software which the host controller 912 is connected to. The client software 916 (the top layer of the host communications layer) requests data from the USBD in the form of input/output request packets (IRP's) which consist of a request to send/receive data through a certain pipe. The USBD handles these requests. The USBD also supplies the client software 918 a general description of the device which the software is about to handle. The USBD is required to handle the enumeration process. The enumeration process is a process that is activated the moment a USB device 902 is attached to the bus and ends once the device is fully configured. The USBD investigates the different configurations of a connected USB device 902 and supplies this knowledge to the client software 918. The USBD owns the default pipe 926, since when a USB device 902 enters the system, the only way to communicate with the USB device 902 is through the default pipe 926.

The USB logical device 924 is composed of a collection of independent endpoints. Each endpoint is given a unique address (endpoint number) at the design time. The USB logical device 924 is also uniquely addressed at the end of the enumeration process. An endpoint is unidirectional except for endpoint number zero. An endpoint may be of an in type that supports data transfer from the USB device 902 to the host 904 or an out type that supports data transfer from the host 904 to the USB device 902. Thus, for bi-directional flow two endpoints are required for each different direction. The combination of the USB logical device address, and endpoint number in the direction of the endpoint define uniquely a certain endpoint. An endpoint is also characterized with a transfer type.

All USB devices 902 must support communication through the default pipe 926. The default pipe 926 plays an important role in the enumeration process, and is the only communication channel to the USB device 902 at attachment. The default pipe 926 is associated with endpoint zero. Endpoint number zero is composed of two endpoints (one IN and one OUT) that share the same endpoint number and are referred to as one endpoint.

The application layer 916 appears as the client software 916 in the host 904 and as the device function 920 in the USB device 902. The device function 920 is composed of a collection of interfaces that control the functionality of the USB device 902. The client software 918 manages the appropriate interface by transferring data from its buffers to the endpoints associated with the appropriate interfaces over a pipe of the pipe bundle 928. The client software 918 works with a specific device function, independent of the other functions in the system. The logic communication between the client software 916 in the host 904 and the device functions 920 in the USB device 902 is done through pipes 928. A pipe 928 is the association between a specific endpoint on the USB device 902 and the appropriate software in the USB host 904. An endpoint is the source or destination of the data that is transmitted on the USB cable 908. An interface is composed of endpoints grouped together into a certain set. The client software 918 wishes to transmit data between the buffers in the host 904 and the endpoints in the USB device 902 and by that manages the specific interface.

The USB host 904 handles most of the complexity of the USB protocol. Data flow within the USB protocol can be from the host device 904 to the USB device 902 and from the USB device 902 to the host device 904. USB transactions are done through packets. Each transaction is composed of three stages. The token stage wherein the host initiates a token indicating a future transaction type. The data stage includes the actual data to be transmitted through a packet. The data direction matches the direction indicated by the token that was originally transmitted. Finally, the handshake phase, which is optional, indicates the success or failure of the transaction.

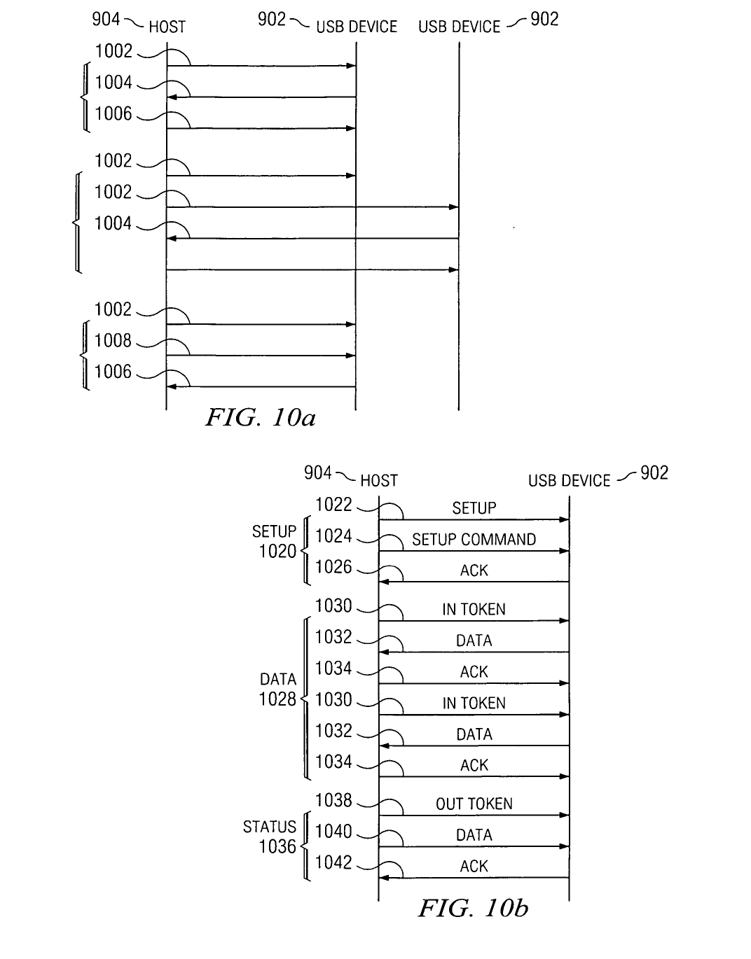

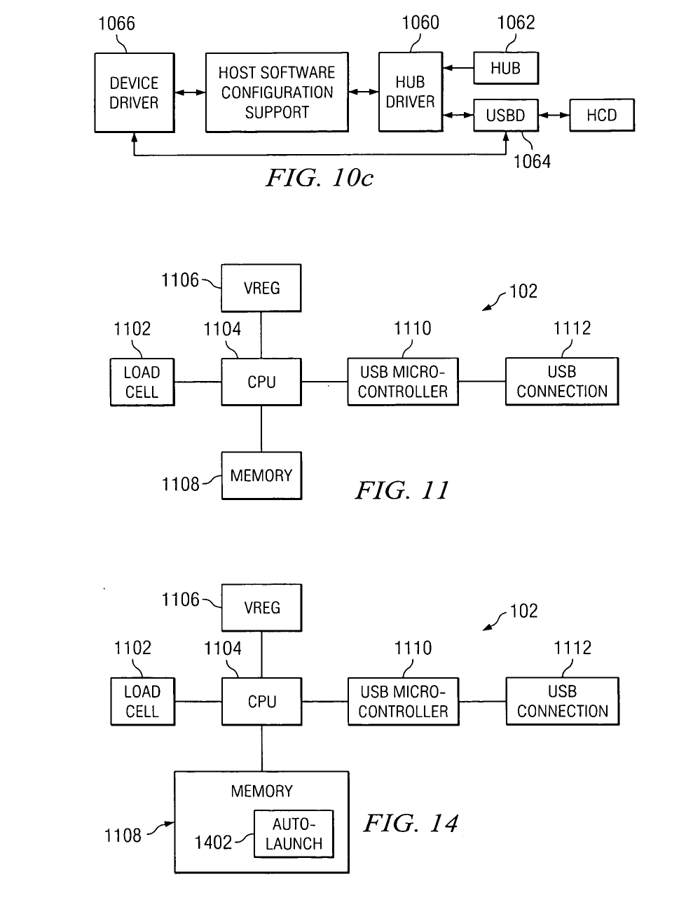

In FIG. 10a, there is illustrated an example of operation of the USB protocol. The USB uses a polling protocol. Whenever the host wishes to receive data from a USB device 902, the host 904 issues a token 1002 addressed to the specific USB device 902. If the USB device 902 has data to transmit to the host, it transmits the data 1004 to the USB host 904 after receiving the token 1002, and the host 904 will respond with a handshake packet 1006 if necessary. If the USB device 902 does not have any data to transmit to the host 904, the host 904 will issue the token 1002 to a next USB device 902. If the host 904 wishes to send data to the USB device 902, the host 904 will transmit the appropriate token 1002 and data packet 1008 to the USB device 902. The device 902 responds to the host data packet 1008 with a handshake packet 1006, if appropriate.

There are four main types of USB transfers. Isochronous transfers are used for multimedia devices such as audio, video, etc. Bulk transfers are used for the transmission of a massive amount of data such as that used by printers, scanners, etc. An interrupt transfer is a limited-latency transfer and is used for devices such as a mouse or joy stick that need to report short event notification, characters or coordinates. Finally, a control transfer is used to configure a device. A configuration is done at the enumeration process but can be done at any state of the communication process. When a USB device enters the system, the host needs to learn about it and configure it at the appropriate configuration. This communication is done using the control transfer. Control transfers may also include special messages defined by the vendor of the USB device. With respect to the USB scale of the present disclosure, the operation of the control transfer is of most interest.

FIG. 10b illustrates a control transfer between a host 904 and a USB device 902. A control transfer is composed of three or two phases. These phases include setup, data (optional) and status. Each of these phases is composed of a token stage, a data stage and a handshake stage. The setup phase 1020 is used to indicate to the USB device 902 which setup command the host 904 wishes to send. At the beginning of a setup phase 1020, the host 904 issued a setup token 1022, followed by the setup command packet 1024. The USB device 902 must respond with an acknowledge packet 1026.

The data phase 1028 (if included) contains the flow of the data, and which direction the data is flowing. The data phase 1028 is composed of one or more IN or OUT transactions. However, all the transactions in the data phase 1028 must be in the same direction. Each transaction in the data phase 1028 begins with an IN/OUT token 1030 issued by the host. Afterwards data 1032 is sent, and the transaction ended with a handshake packet 1034.

The status phase 1036 reports to the host 904 the results of the setup 1020 and data 1028 stages. The report is always from the USB device 902 to the host 904. The data flow direction of the status phase 1036 is always the opposite of that of the data phase 1028. The status stage 1036 begins with transmission of an OUT token 1038 from the host 904 to the USB device 902. A data packet 1040 is transmitted from the host 904 to the USB device 902, and the USB device 902 in response thereto transmits an acknowledge packet 1042 back to the host 904;

FIG. 10c more fully illustrates the configuration interactions when a USB device (USB scale 102) is connected to a host device (PC 104). When a USB device 902 is attached, the hub driver 1060 receives a notification from the hub 1062 to which a USB device 902 has been connected. The hub driver 1060, using the information provided by the hub 1062, requests a device identifier from the USBD 1064. The USBD 1064 in turn sets up the default pipe 926 for the USB device 902 and returns a device identifier to the hub 1060. The device 902 is now ready to be configured for use. When a peripheral device 902 is first connected to the USB, the host 904 detects the presence of the connected peripheral device 902 and the configuration process begins. The configuration process assigns a unique USB address to the connected peripheral device 902, queries the connected peripheral device 902 about requirements and capabilities, writes data about the connected peripheral device 902 into the operating system of the host 904 and loads the appropriate software device driver 1066 from the storage location into the operating system. The device driver 1066 is a program that allows the operating system to communicate directly with the peripheral device 902 and provides information to the computer operating system about the peripheral device 902.

For each device 902, there are three configurations that must be completed before the device 902 is ready to use. The first configuration involves USB device configuration. This includes setting up of all of the devices USB parameters and allocating all USB host resources that are visible to the USB device 902. This is accomplished by setting the configuration value for the device. A limited set of configuration changes, such as alternate settings, are allowed without totally reconfiguring the device. The USB configuration must also be performed. In order to actually create a pipe 928 ready for use by a connected USB device 902, additional USB information not visible to the device must be specified by the client. This information known as the policy for the pipe 928, describes how the USB device 902 will use pipe 928. This includes such items as maximum amount of data the USB device 902 will transfer with IRP, the maximum service interval the USB device 902 will use, and the notification identification. Finally, the function configuration must be performed. This involves additional vendor or class specific set up which may be required before the USB device 902 can actually use the pipe 928. The responsible configuring software performs the actual device configuration. Depending on the particular operating system implementation, the software responsible for configuration can include the hub driver 1060, other host software or a device driver 1066.

The configuring software first reads the device descriptor and requests the description for each possible configuration. It may use the information provided to load a particular client, such as a device driver 1066, which initially interacts with the device. The configuring software, perhaps with input from the device driver 1066, chooses a configuration for the device. Setting the device configuration sets up all of the end points on the device and returns a collection of interfaces to be used for data transfer by USBD clients. Each interface is a collection ofpipes owned by a single client. This initial configuration uses the default settings for interfaces and the default parameters for each end point. A USBD implementation may additionally allow the client to specify alternate interfaces when selecting the initial configuration. The USB system will verify that the resources required for support of the end point are available and if so will allocate the bandwidth required.

Once the device is configured the created pipes 928 must be made ready for use. The USB configuration is accomplished when the client initializes each pipe by setting a policy to specify how it will interact with the pipe. Among the information specified is the client's maximum service interval and notification information. Among the actions taken by the USB system, as a result of setting the policy, is determining the amount of buffer working space required beyond the data buffer space provided by the client. The size of the buffers required is based upon the usage chosen by this client and upon the data transfer needs of the USB system. The client receives notification when IRP (Input/Output request packet) is complete, successfully or due to errors. The client may wake up independently at the USB notification to seek status of pending IRP's. The client may also choose to make configuration modifications, such as enabling setting for an interface or changing the band width allocated to a particular pipe 928. In order to perform these changes the interface pipe 926 must be idle.

Referring now to FIG. 11, there is illustrated a functional block diagram of the USB scale 102. A load cell 1102 generates a weight signal responsive to the weight of an item placed upon the weight pad 204 of the universal serial bus scale 102. A weight signal from the load cell 1102 is provided to a central processing unit (CPU) 1104 which controls the operations of the universal serial bus scale 102. The CPU 1104 generates the weight data necessary to actuate the USB scale software 106. A voltage regulator 1106 provides a regulated voltage to the central processing unit 1104. A memory 1108 contains instructions for controlling the CPU 1104 and in some embodiments, may also temporarily or permanently store weight data generated by the CPU 1104. The central processing unit 1104 outputs weight data to a universal serial bus microcontroller 1110. The USB microcontroller 1110 controls information transmitted over the universal serial bus cable interconnecting the USB scale 102 to a PC 104. The USB microcontroller 1110 manages the USB connection 1112 that interconnects the USB scale 102 with a connected universal serial bus cable. In addition to transmitting data, the power for the USB scale 102 is provided through the USB connection 1112 by a connected USB cable.

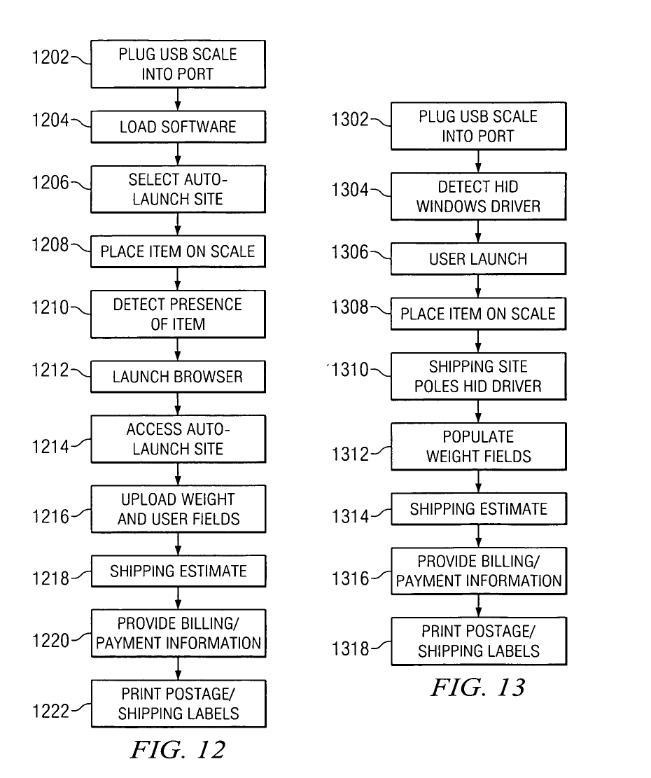

Referring now to FIG. 12, there is illustrated a flow diagram describing the operation of the USB scale and its associated software within the PC 104 using a client push method of operation. Initially, the USB scale is plugged into the USB port at step 1202. Next, the software for controlling the USB scale and the autolaunch functionality are loaded into the associated personal computer 104 at step 1204. During setup of the software, the autolaunch site to be associated with the USB scale is selected at step 1206. Once the USB scale and associated software have been configured, an item can be placed upon the USB scale 102 at step 1208. When the USB software 106 detects the presence of an item on the USB scale at step 1210 responsive to receipt of weight data from the USB scale 102, the browser enabling interconnection with the Internet is launched at step 1212. The browser is directed to the autolaunch site at step 1214 that was selected at step 1206. Once the autolaunch site has been accessed the weight data received from the USB scale is uploaded to the accessed Web site and placed in the weight fields of the Web site at step 1216. Using the uploaded information the Web site will provide shipping estimates at step 1218 back to the PC over the launched browser. A user deciding to ship according to the provided shipping estimates may provide billing and payment information at step 1220 to the Web site either manually or automatically using the user and billing information entered into the USB scale software as part of the set up process. The user may print any necessary postage/shipping labels necessary to complete the shipping transaction at step 1222.

Referring now to FIG. 13, there is illustrated a flow diagram describing the operation of the USB scale 102 and associated software 106 using a server pull operation. As before, with a client push operation, the process begins by plugging the USB scale into a USB port at step 1302. Upon detection of the USB scale 102 to the PC 104, the Windows operating system sees the USB scale as an HID and auto installs the appropriate drivers at 1304. A user launches their favorite shipping Web site manually at step 1306. An item to be weighed is placed on the USB scale at step 1308. The shipping site accessed via the Web browser will poll the windows HID driver using an Active X for Java script client at step 1310 to access the weight data. The received weight data is used to populate, at step 1312, the weight fields in the accessed Web site. A shipping estimate is provided back to the user at step 1314 using the provided weight data. Based upon the received shipping information the user may decide to provide billing/payment information to the Web site using the information previously stored within the USB scale software 106. Finally, the transaction will be completed by printing out necessary postage/shipping labels at step 1318.

Referring now to FIG. 14, there is illustrated an alternative embodiment of the USB scale 102. The configuration of the USB scale 102 in this alternative embodiment is similar to that illustrated and described with respect to FIG. 11. A CPU 1104 is interconnected with a load cell 1102 for measuring weights of items placed upon the USB scale 102, a voltage regulator 1106 for providing a regulated voltage to the CPU 1104, a USB microcontroller 1110 for controlling interactions with the USB connection 1112 and a memory 1108 for storing information and programming for controlling operation of the USB scale 102. The main difference between the embodiments of FIGS. 11 and 14 is that the USB scale autolaunch software 1402 is stored within the memory 1108 of the USB scale 102. Thus, rather than installing the software upon a PC 104 to which the USB scale 102 is connected, the autolaunch software 1402 will be integrated within the universal serial bus scale 102. When a weight signal is provided from the load cell 1102 to the CPU 1104, the autolaunch software 1402 will provide instructions to a PC connected to the USB scale 102 through the USB connection 1112 to launch a browser to enable automatic access to a pre-selected web site. The autolaunch software 1402 will populate weight fields within the automatically accessed web site using either a push operation or a pull operation in the manner described herein above. The autolaunch software 1402 would also have the ability to be accessed via an external PC 1102 to alter or select the autolaunch web site or sites to which the software will automatically open in response to receipt of a weight signal from the weight scale 1102.

Using the above described system and method an individual may automatically provide weight data to a weight field of a shipping website. This prevents shipping cost calculation errors based on incorrect weight estimates provided by a user, and enables quick, accurate determinations of shipping costs at a user selected web site.

Although the preferred embodiment has been described in detail, it should be understood that various changes, substitutions and alterations can be made therein without departing from the scope of the invention as defined by the appended claims.

What is claimed is:

1. A system for providing weight data from a computer to a web site, comprising:
a weight scale connected to the computer via a universal serial bus connection for providing weight data to the computer; and
a computer readable storage media containing machine readable code for configuring a processor in the computer to send the weight data the weight data to the web site responsive to receipt of the weight data at the computer.

2. The system of claim 1, wherein the machine readable code further configures the processor to send the weight data to the web site using a push operation.

3. The system of claim 1, wherein the machine readable code further configures the processor to send the weight data to the web site using a pull operation.

4. The system of claim 1, wherein the machine readable code further configures the processor to provide a graphical user interface, the graphical user interface providing a display of a weight value responsive to the weight data.

5. The system of claim 1, wherein the machine readable code further configures the processor to provide a graphical user interface, the graphical user interface enabling a user to selectively designate the web site to which the computer sends weight data.

6. The system of claim 5, wherein the graphical user interface provides a plurality of preselected web sites for selection by the user.

7. The system of claim 5, wherein the graphical user interface enables the user to enter a designated web site as the web site.

8. The system of claim 5, wherein the graphical user interface enables the selection of a plurality of measurement units for displaying the weight data.

9. The system of claim 1, wherein the machine readable code further configures the processor to automatically access the web site responsive to receipt of the weight data.

10. The system of claim 9, wherein the machine readable code further configures the processor to automatically access the web site using a web browser.

11. The system of claim 1, wherein the machine readable code further configures the processor to automatically send the weight data to the web site responsive to receipt of the weight data.

12. The system of claim 1, wherein the machine readable code further configures the processor to provide billing data to the web site.

13. The system of claim 1, wherein the weight scale further comprises:
a load cell for generating a weight signal;
a processor for generating the weight data responsive to the weight signal; and
a USB controller connected to the processor for controlling a USB connection of the weight scale.

14. An apparatus, comprising:
a computer-readable storage medium containing a set of instructions for a general purpose computer; and
wherein execution of the set of instructions by the general purpose computer configures the general purpose computer to send weight data to a web site responsive to receipt of the weight data.

15. The apparatus of claim 14, wherein the execution of the set of instructions by the general purpose computer further configures the general purpose computer to send the weight data to the web site using a push operation.

16. The apparatus of claim 14, wherein the execution of the set of instructions by the general purpose computer further configures the general purpose computer to send the weight data to the web site using a pull operation.

17. The apparatus of claim 14, wherein the execution of the set of instructions by the general purpose computer further configures the general purpose computer to provide a graphical user interface, the graphical user interface providing a display of a weight value responsive to the weight data.

18. The apparatus of claim 14, wherein the execution of the set of instructions by the general purpose computer further configures the general purpose computer to provide a graphical user interface, the graphical user interface enabling a user to selectively designate the web site to which the computer sends weight data.

19. The apparatus of claim 18, wherein the graphical user interface provides a plurality of preselected web sites for selection by the user.

20. The apparatus of claim 18, wherein the graphical user interface enables the user to enter a designated web site as the web site.

21. The apparatus of claim 18, wherein the graphical user interface enables the selection of a plurality of measurement units for displaying the weight data.

22. The apparatus of claim 14, wherein the execution of the set of instructions by the general purpose computer further configures the general purpose computer to automatically access the web site responsive to receipt of the weight data.

23. The apparatus of claim 22, wherein the execution of the set of instructions by the general purpose computer further configures the general purpose computer to automatically access the web site using a web browser.

24. The apparatus of claim 14, wherein the execution of the set of instructions by the general purpose computer further configures the general purpose computer to automatically send the weight data to the web site responsive to receipt of the weight data.

25. The apparatus of claim 14, wherein the execution of the set of instructions by the general purpose computer further configures the general purpose computer to provide billing data to the web site.

26. A method for providing weight data from a computer to a web site, comprising the steps of:
detecting weight data provide from a weight scale connected via a universal serial bus connection;
sending the weight data to the web site responsive to receipt of the weight data without any user input.

27. The method of claim 26, wherein the step of sending the weight data further includes the step of sending the weight data to the web site using a push operation.

28. The method of claim 26, wherein the step of sending the weight data further includes the step of sending the weight data to the web site using a pull operation.

29. The method of claim 26, further including the step of displaying a weight value responsive to the weight data.

30. The method of claim 26, further including the step of receiving a user designated selection of the web site to which the weight data is sent.

31. The method of claim 30, wherein the step of receiving a user designated selection of the web site further includes the step of providing a plurality of preselected web sites for selection by the user.

32. The method of claim 30, wherein the step of receiving a user designated selection of the web site further includes the step of receiving a user entered web site as the designated selection of the web site.

33. The method of claim 26, further including the step of designating measurement units for displaying the weight data.

34. The method of claim 26, wherein the machine readable code further configures the processor to automatically launch a browser responsive to receipt of the weight data.

35. The method of claim 34, wherein the machine readable code further configures the processor to automatically access the web site via the web browser responsive to receipt of the weight data.

36. The method of claim 26, wherein the step of sending further comprises the step of automatically sending the weight data to the web site responsive to receipt of the weight data.

37. The method of claim 26, further including the step of sending billing data to the web site.
